(19) United States
(12) Patent Application Publication
(10) Pub. No.: US 2016/0107920 A1
(43) Pub. Date: Apr. 21, 2016

(54) MULTI-STAGE HEATING APPARATUS

(71) Applicant: TUNG CHANG MACHINERY AND ENGINEERING CO., LTD, Taoyuan County (TW)

(72) Inventor: CHUN-PENG CHEN, Taoyuan County (TW)

(21) Appl. No.: 14/519,282

(22) Filed: Oct. 21, 2014

(51) Int. Cl. C03B 27/012; F27B 9/02; C03B 35/00; F27D 19/00

(52) U.S. Cl. CPC C03B 27/012; F27D 19/00; F27B 9/02; C03B 35/00

(57) ABSTRACT

A multi-stage heating apparatus includes a cover, plural driving modules and plural heating modules to form a manufacture area that covers most of the different sized workpieces. With the integration of a control circuit, users simply reset or selecting control parameters of each driving module and each heating module through the control circuit to generate a heating mode for workpieces of different sizes. This apparatus not just fulfills the operating requirement of different sized workpieces only, but also lowers the equipment cost effectively.

### FIELD OF THE INVENTION

The present invention relates to a heating apparatus, in particular to a multi-stage heating apparatus capable of setting a heating mode of the heating apparatus quickly according to the requirements for different sized workpieces.

### BACKGROUND OF THE INVENTION

In general, glass products are manufactured by manufacturing processes such as material preparing, melting, forming and annealing processes, wherein the forming process converts melted liquid glass into solid glass products with a fixed shaped. Although this process is a cooling process, it is still taken place within a specific temperature range in rode to convert the glass from a viscous liquid state into a malleable state, and further to a brittle solid state successfully.

In any automated production equipment that requires heating a workpiece, at least one heating process must be scheduled to maintain or resume the workpiece in a predetermined temperature range. In FIG. 1, a heating apparatus 12 is installed at a set stroke of a conveying equipment 11, such that when the workpiece 20 is conveyed by the conveying equipment 11, the workpiece 20 passing through the heating apparatus 12 is maintained or resumed within its predetermined temperature range.

In an automated production line, the conveying speed and interval of the workpieces 20 must be specified to maintain a required production speed, so that the scale of the heating apparatus 12 must be able to heat the passing workpieces 20 to an operating temperature in a predetermined time.

Even more, some of the automated production line includes several heating apparatuses 12 as shown in FIG. 2 to heat various types of workpieces 20, so that the same production line can heat a plurality of workpieces 20 simultaneously and achieve the required production capacity. However, such arrangement incurs a much higher equipment cost for the manufacture.

In addition, each heating apparatus 12 includes a heating element 122 and a cover 121 having two end openings with a sufficient gap apart from each other to prevent heat loss, or even further coming with a covering design for the two end openings of the cover 121. In other words, if the length or size of the workpiece 20 is greater than that of the heating apparatus 12, the manufacturing requirement for a large-size workpiece 20 can not be satisfied by connecting a plurality of heating apparatuses 12.

Therefore, it is an important subject for related manufacturers to lower the equipment cost and a long-desired unmet need of providing a heating apparatus capable of satisfying the operating requirements for different sized workpieces.

### SUMMARY OF THE INVENTION

Therefore, it is a primary objective of the present invention to provide a multi-stage heating apparatus capable of setting a corresponding heating mode for the requirement of different sized workpieces.

To achieve the aforementioned objective, the present invention provides a multi-stage heating apparatus, comprising: a conveying module, including a plurality of carrier modules sequentially installed on a stand and contacted with a workpiece, and the carrier modules being connected in series for conveying the workpiece passing through a conveying stroke; a plurality of driving modules, sequentially installed positions adjacent to the conveying stroke of the conveying module, and transmitted and linked with the set carrier module, for driving each carrier module to move in an operation; a plurality of heating modules, sequentially installed at positions adjacent to the conveying stroke of the conveying module, for producing a heat source for the conveying stroke during the operation; a cover, covered onto the top of the conveying stroke of the conveying module, for covering all of the heating modules and the conveying module corresponsive to both sides of the conveying stroke of the heating module, and the cover having an opening formed at both covered ends of the conveying stroke separately for passing the workpieces; and a control circuit, electrically coupled to each driving module and each heating module, for setting at least one heating mode for integrating control parameters of each driving module and each heating module, and controlling and determining whether or not to operate each driving module and each heating module according to the set heating mode.

With the aforementioned structure, the multi-stage heating apparatus of present invention is comprised of a cover, a plurality of driving modules and a plurality of heating modules that form a manufacturing capable of covering most workpieces of different sizes. During use, the control circuit is provided for setting at least one heating module of an operation for the manufacturing requirement of small-size workpieces, or setting the operation of some or all heating modules to meet the manufacturing requirement of large-size workpieces, and the operating speed and operating direction of each driving module may be set in order to heat the workpieces of different sizes to a predetermined temperature within the time for the workpiece of different sizes to pass through the cover. When the size of the workpiece to be manufactured is changed, users simply reset or select the control parameters of each driving module and each heating module through the control circuit to obtain the corresponding heating mode quickly.

Wherein, the cover has a heat insulating material coated on an inner wall of the cover.

Wherein, the control circuit is electrically coupled to a plurality of temperature sensing elements installed in the cover.

Wherein, the cover includes a heat insulating material coated on an inner wall of the cover, and the control circuit is electrically coupled to a plurality of temperature sensing elements installed in the cover.

Each carrier module is a roller.

Each driving module is a forward/reverse servomotor for driving the carrier module coupled to the driving module.

Each heating module is an electric heating module.

The heat insulating material is glass, ceramic or quartz.

The roller is made of a material which is glass, ceramic or quartz.

Specifically, the multi-stage heating apparatus of the present invention is comprised of a cover, a plurality of driving modules and a plurality of heating modules to form a manufacture area capable of covering most workpieces of different sizes. With the integration of a control circuit, users simply reset or selecting control parameters of each driving module and each heating module through the control circuit to generate a heating mode for workpieces of different sizes. This apparatus not just fulfills the operating requirement of different sized workpieces only, but also lowers the equipment cost effectively.

### BRIEF DESCRIPTION OF THE DRAWINGS

FIG. 1 is a schematic view of the layout of a conventional production line of glass products;

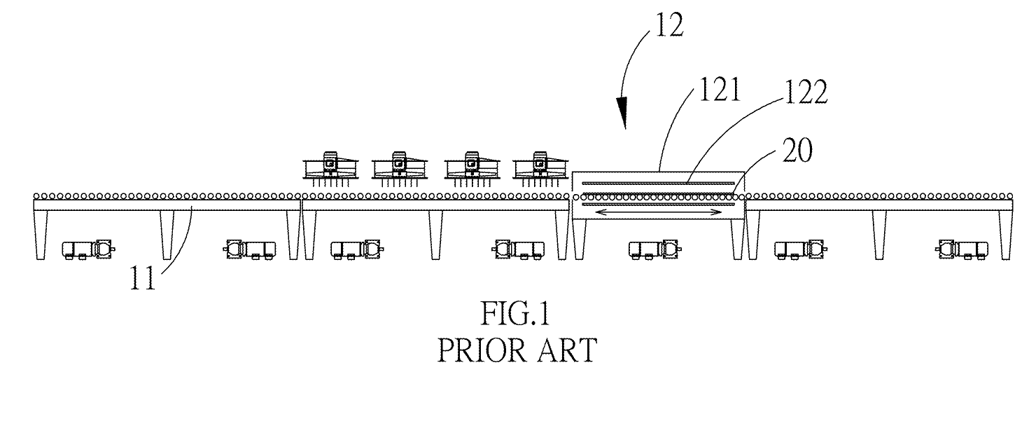

FIG. 2 is a schematic view of the layout of another conventional production line of glass products;

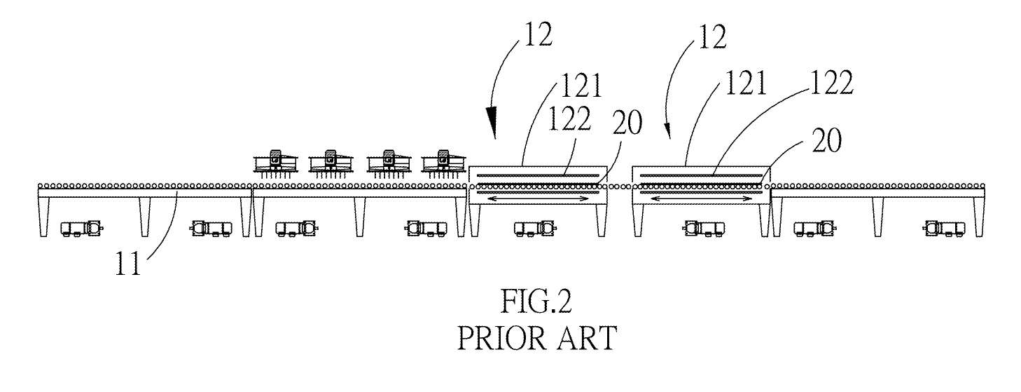

FIG. 3 is a perspective view of a multi-stage heating apparatus of the present invention.

FIG. 4 is a schematic view of an application of a multi-stage heating apparatus applied in the heating operation of small-size workpieces; and

FIG. 5 is a schematic view of an application of a multi-stage heating apparatus applied in the heating operation of large-size workpieces.

### DESCRIPTION OF THE PREFERRED EMBODIMENTS

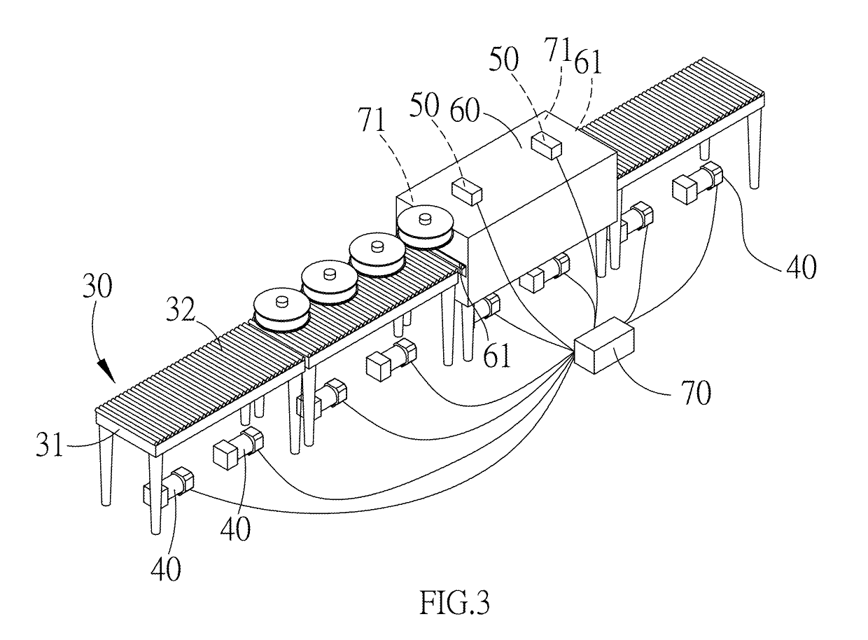

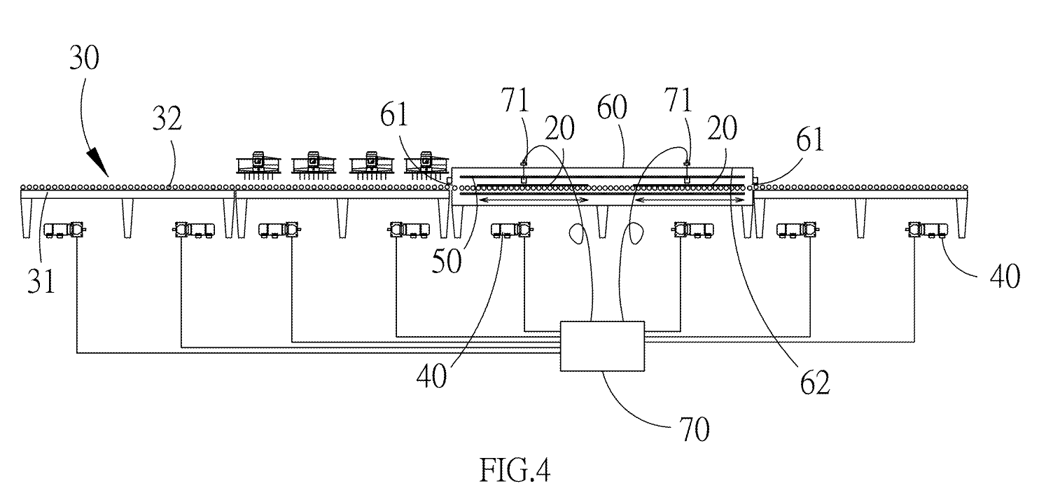

The present invention provides a multi-stage heating apparatus capable of setting a corresponding heat mode quickly according to the requirements for workpieces of different sizes. With reference to FIGS. 3 and 4 for a perspective view of a multi-stage heating apparatus of the present invention and a schematic view of an application status of a multi-stage heating apparatus of the present invention applied in a heating operation of small-size workpieces respectively, the multi-stage heating apparatus comprises a conveying module 30, a plurality of driving modules 40, a plurality of heating modules 50, a cover 60, and a control circuit 70.

The conveying module 30 includes a plurality of carrier modules 32 sequentially installed on a stand 31 and contacted with a workpiece 20, and the carrier modules 32 are connected in series for conveying the workpiece 20 passing through a conveying stroke. In an embodiment, each carrier module 32 is a roller.

The driving module 40 are sequentially installed positions adjacent to the conveying stroke of the conveying module 10, and transmitted and linked with the set carrier module 32 for driving each carrier module 32 to move in an operation. In an embodiment, each driving module 40 is a forward/reverse servomotor for driving the carrier module 32 coupled to the driving module 40.

The heating modules 50 are sequentially installed at positions adjacent to the conveying stroke of the conveying module 30 for producing a heat source for the conveying stroke during the operation. In an embodiment, each heating module 50 is an electric heating module for producing a heat source after the heating module 50 is powered on.

The cover 60 is covered on the top of the conveying stroke of the conveying module 30, and provided for covering all of the heating modules 50 and the conveying modules 30 corresponsive to both sides of the conveying stroke of the heating module 50, and an opening 61 is formed separately at both end positions of the covered conveying stroke and provided for passing through the workpiece 20.

The control circuit 70 is electrically coupled to each driving module 40 and each heating module 50 for setting at least one heating mode for integrating the control parameters of each driving module 40 and each heating module 50, and controlling and determining whether or not to operate each driving module 40 and each heating module 50 according to the set heating mode.

Basically, the multi-stage heating apparatus of the present invention is comprised of a cover 60, a plurality of driving modules 40 and a plurality of heating modules 50 to form a manufacture area capable of covering most workpieces of different sizes. During use, the control circuit 70 is provided for setting at least one heating module 50 according to an operating requirement for small-size workpieces 20, or setting some or all of the heating modules 50 to meet the operating requirement for large-size workpieces 20. In addition, the operating speed and operating direction of each driving module 40 may be set, so that the workpieces 20 of different sizes passing through the cover 60 is heated to a predetermined temperature within a predetermined time in a heating process such as those for heating large-size workpieces with a length of 4500 mm˜8500 mm and a width of 300 mm˜2500 mm, or small-size workpieces with a length of 350 mm˜4200 mm and a width of 150 mm˜2500 mm.

In an embodiment as shown in FIG. 4, all heating modules 50 are operated and each driving module 40 is operated according to the set timing and operated at different speeds, so that the workpieces 20 may be moved back and forth within the manufacture area covered by the cover 60, so as to achieve the effect of heating the plurality of workpieces 20 to a predetermined operating temperature simultaneously.

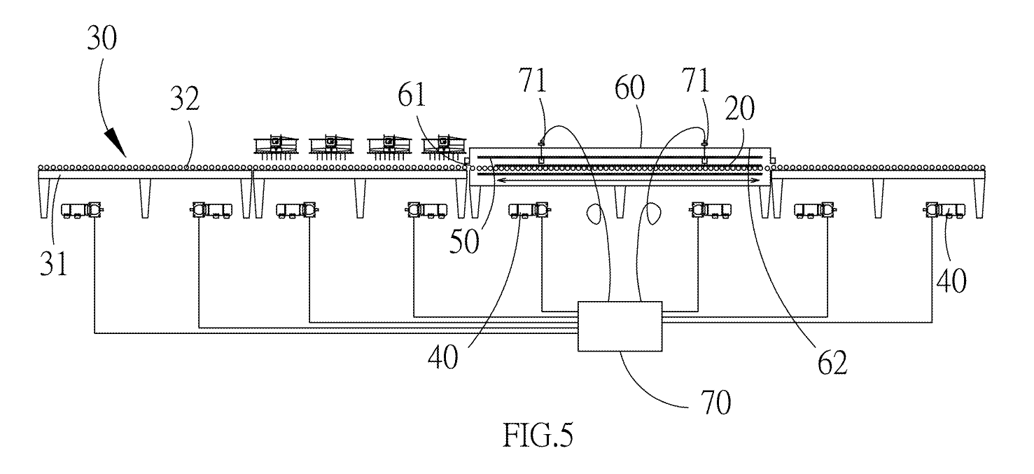

When the size of the workpiece 20 to be manufactured is changed, users simply reset or select the control parameters of each driving module 40 and each heating module 50 through the control circuit 70 to obtain a corresponding heating mode quickly. In an embodiment as shown in FIG. 5, all heating modules 50 are operated and all driving modules 40 are operated according to a set timing and the operating speed is changed in order to heat the large-size workpiece 20 to a predetermined temperature.

In addition, the cover 60 includes a heat insulating material 62 coated on an inner wall of the cover to prevent the loss of heat source. The control circuit 70 is electrically coupled to a plurality of temperature sensing elements 71 installed in the cover 60 for monitoring and controlling whether or not the multi-stage heating apparatus is maintained at a predetermined operating temperature.

In a preferred embodiment of the multi-stage heating apparatus of the present invention, the cover 60 includes a heat insulating material 62 coated on an inner wall of the cover 60; and the control circuit 70 is electrically coupled to the temperature sensing elements 71 in the cover 60.

Compared with the prior art, the multi-stage heating apparatus of the present invention, the multi-stage heating apparatus of the present invention is comprised of a cover, a plurality of driving modules and a plurality of heating modules to form a manufacture area capable of covering most workpieces of different sizes. With the integration of a control circuit, users simply reset or selecting control parameters of each driving module and each heating module through the control circuit to generate a heating mode for workpieces of different sizes. This apparatus not just fulfills the operating requirement of different sized workpieces only, but also lowers the equipment cost effectively.

What is claimed is:

1. A multi-stage heating apparatus, comprising:
a conveying module, including a plurality of carrier modules sequentially installed on a stand and contacted with a workpiece, and the carrier modules being connected in series for conveying the workpiece passing through a conveying stroke;
a plurality of driving modules, sequentially installed at positions adjacent to the conveying stroke of the conveying module, and transmitted and linked with the set carrier module, for driving each carrier module to move in an operation;
a plurality of heating modules, sequentially installed at positions adjacent to the conveying stroke of the conveying module, for producing a heat source for the conveying stroke during the operation;
a cover, covered onto the top of the conveying stroke of the conveying module, for covering all of the heating modules and the conveying module corresponsive to both sides of the conveying stroke of the heating module, and the cover having an opening formed at both covered ends of the conveying stroke separately for passing the workpieces; and
a control circuit, electrically coupled to each driving module and each heating module, for setting at least one heating mode for integrating control parameters of each driving module and each heating module, and controlling and determining whether or not to operate each driving module and each heating module according to the set heating mode.

2. The multi-stage heating apparatus of claim 1, wherein the cover has a heat insulating material coated on an inner wall of the cover.

3. The multi-stage heating apparatus of claim 1, wherein the control circuit is electrically coupled to a plurality of temperature sensing elements installed in the cover.

4. The multi-stage heating apparatus of claim 1, wherein the cover includes a heat insulating material coated on an inner wall of the cover, and the control circuit is electrically coupled to a plurality of temperature sensing elements installed in the cover.

5. The multi-stage heating apparatus of claim 1, wherein each carrier module is a roller.

6. The multi-stage heating apparatus of claim 1, wherein each driving module is a forward/reverse servomotor for driving the carrier module coupled to the driving module.

7. The multi-stage heating apparatus of claim 1, wherein, each heating module is an electric heating module.

8. The multi-stage heating apparatus of claim 2, wherein the heat insulating material is one selected from the group consisting of glass, ceramic and quartz.

9. The multi-stage heating apparatus of claim 4, wherein the heat insulating material is one selected from the group consisting of glass, ceramic and quartz.

10. The multi-stage heating apparatus of claim 5, wherein the roller is made of a material selected from the group consisting of glass, ceramic and quartz.

11. A multi-stage heating apparatus, comprising:
a conveying module, including a plurality of carrier modules sequentially installed on a stand and contacted with a workpiece, and the carrier modules being connected in series for conveying the workpiece passing through a conveying stroke, and each carrier module being a roller made of quartz;
a plurality of driving modules, sequentially installed at positions adjacent to the conveying stroke of the conveying module, and transmitted and linked with the set carrier module, for driving each carrier module to move in an operation, and each driving module being a forward/reverse servomotor for driving the carrier module coupled to the driving module;
a plurality of heating modules, sequentially installed at positions adjacent to the conveying stroke of the conveying module, for producing a heat source for the conveying stroke during the operation, and each heating module being an electric heating module;
a cover, covered onto the top of the conveying stroke of the conveying module, for covering all of the heating modules and the conveying module corresponsive to both sides of the conveying stroke of the heating module, and the cover having an opening formed at both covered ends of the conveying stroke separately for passing the workpieces, and the cover having a heat insulating material coated onto an inner wall of the cover, and the heat insulating material being ceramic; and
a control circuit, electrically coupled to each driving module and each heating module, for setting at least one heating mode for integrating control parameters of each driving module and each heating module, and controlling and determining whether or not to operate each driving module and each heating module according to the set heating mode, and the control circuit being electrically coupled to a plurality of temperature sensing elements installed in the cover.
